(19) United States
(12) Patent Application Publication
(10) Pub. No.: US 2012/0271704 A1
(43) Pub. Date: Oct. 25, 2012

(54) PROVIDING DIFFERENTIATED EARN RATE REWARDS IN A LOYALTY PROGRAM BASED ON THE VALUE OF THE PROGRAM PARTICIPANT

(75) Inventors: Srinath Nagarajan, Waltham, MA (US); Erik Stephen Ross, Charlotte, NC (US)

(73) Assignee: BANK OF AMERICA CORPORATION, Charlotte, NC (US)

(21) Appl. No.: 13/093,362

(22) Filed: Apr. 25, 2011

(51) Int. Cl. G06Q 30/00

(52) U.S. Cl. 705/14.33; 705/14.27

(57) ABSTRACT

Embodiments of the invention provide for a loyalty rewards program that provides differentiated earn rate rewards based on participant/customer segmentation. In specific embodiments the segmentation is based on the value of the participant/customer as determined by the rewards program provider. Additionally further details are described below for methods, apparatus and computer-program products that provide for a rewards program that implements reverse auction type reward procurement. Such embodiments of the invention, offer differentiated rewards redemption based on the value of the participant to the program provider and the value that the participant/customer places on the reward.

### FIELD

In general, embodiments of the invention relate to customer loyalty rewards programs and, more particularly, to providing differentiated earn rate rewards in a loyalty program based value of the participant/customer as viewed by the rewards program provider.

### BACKGROUND

Loyalty rewards programs are structured marketing efforts that reward customers/participants, and therefore encourage, loyal buying behavior. Such loyalty to a particular, business, product, service or the like is typically highly beneficial to the business or other entity implementing the loyalty rewards programs. Examples, of loyalty rewards program providers include airlines, hotels, retailers, financial institutions and the like.

Traditionally, loyalty rewards programs are structured such that customers/participants earn loyalty rewards program points through purchases associated with the program provider or their affiliates/partners. For example, if the rewards program provider is an airline, purchased flights result in rewards program points, as well as purchases made with the airlines rewards partners/affiliates, such as stays at partnered/affiliated hotel chains, automobile rentals with partnered/affiliated automobile rental agencies and the like. In turn, once the program participant has acquired sufficient points, the points are used by the participant to acquire products or services.

In the current framework, the loyalty rewards market is largely a commodity play, in that, a single-price (i.e., single-points) catalog is offered to all the participants/customers in the program and, as such, all the participants “pay” the same amount (i.e., redeem the same number of points). Differentiate amongst the participants/customers is generally limited to those participants/customers that have achieved a high level status within the program, such as gold status, platinum status or the like. In such instances in which the participant/customer reaches the higher status level, differentiation may be limited to concierge type services, such as flight upgrades for frequent flyer programs or the like. However, within the higher level status groups the services offered to the participant/customer are generally commoditized such that no differentiation exists amongst the participants in that higher end sector. Additionally, the single-price model in which all participants/customers are treated equally within the rewards program does not factor the consumers willingness to pay different prices (i.e., points amounts) or the providers ability and need to value the participants/customers within the program differently.

In addition, the current single-price catalog “exchange model” does not provide rewards vendors (i.e., third party suppliers of the reward) much in terms of value, in that, the rewards vendors do not typically gain insight into the participant/customer value nor are they able by price their rewards accordingly based on the participant's value.

Therefore, a need exists to develop methods, apparatus, computer program products and the like for loyalty rewards programs that provides rewards to participants/customers based on their value to the rewards program provider. The desired methods, apparatus and computer program products should additionally provide a dynamic pricing model whereby the rewards vendors/service providers gain insight into participant/customer value and can set their prices for rewards accordingly.

### SUMMARY

The following presents a simplified summary of one or more embodiments in order to provide a basic understanding of such embodiments. This summary is not an extensive overview of all contemplated embodiments, and is intended to neither identify key or critical elements of all embodiments, nor delineate the scope of any or all embodiments. The summary's sole purpose is to present some concepts of one or more embodiments in a simplified form as a prelude to the more detailed description that is presented later.

Thus, further details are provided below for methods, apparatus and computer-program products that provide for a loyalty rewards program that provides differentiated earn rate rewards based on participant/customer segmentation. In specific embodiments the segmentation is based on value of the participant/customer as determined by the rewards program provider. Value may be defined based on the volume of business that the participant/customer conducts with the program provider or, in some embodiments in which the reward program is financial institution-based, value may be defined by the net worth of the participant/customer.

In further embodiments of the invention, designated participants/customers, such as higher valued participants/customers may be able to define a desired loyalty rewards, such as through a wish list or the like, and the rewards program may procure the reward through a reverse auction scenario. By providing reverse auction procurement of rewards, the program provider as well as the supplier of the rewards is able differentiate the value that these participants/customers place on the product and gain a more comprehensive understanding of their participants/customers, or at least the higher valued participants/customers.

A method for implementing a loyalty rewards program defines first embodiments of the invention. The method includes identifying a plurality of rewards program participant segments and determining, for each participant in a loyalty rewards program, a participant segment assignment from amongst the plurality of rewards program participant segments. The method further includes providing differentiated reward earn rates to rewards program participants based on the determined participant segment assignment.

In specific embodiments of the method identifying further includes identifying the plurality of rewards program participant segments, such that each segment is identified based on the value of the participants in the segment to the program provider. The value may be defined as the amount of business that the participants in the segment conduct with the rewards program-provider, the net worth of the participants in the segment or the like. In such embodiments of the method, providing differentiated rewards earn rates may further include providing higher reward earn rates to rewards program participants based on the determined participant segment assignment being associated with lower valued participants and/or providing lower reward earn rates to rewards program participants based on the determined participant segment assignment being associated with higher valued participants. In further such embodiments of the method, providing differentiated earn rates may further include providing fixed reward earn rates to rewards program participants based on the determined participant segment assignment being associated with lower valued participants and/or providing dynamic reward earn rates to rewards program participants based on the determined participant segment assignment being associated with higher valued participants. In such embodiments of the method, providing dynamic earn rates may be attributed to participant participation in reverse auctions, whereby the participant identifies a rewards and reward suppliers provide bids on the reward.

Another method for implementing a loyalty rewards program defines second embodiments of the invention. The method includes receiving first and second inputs from a rewards program participant, wherein the first input defines a desired loyalty program reward and the second input defines a maximum rewards point amount that the program participant is willing to redeem for the desired loyalty program reward. The method further includes receiving one or more bids for providing the desired loyalty program reward to the program participant, wherein each bid is from one of a plurality of reward providers and determining a winning bid from the one or more received bids based at least in part on the maximum rewards point amount that the program participant is willing to redeem for the desired loyalty program reward. The method further includes providing the program reward to the program participant from the reward provider determined to be associated with the winning bid.

In specific embodiments of the method receiving the first input further includes receiving the first input, wherein the first input defines a desired loyalty reward currently provided by the loyalty rewards program (e.g., in the providers reward catalog) or, in alternate embodiments, a desired loyalty reward currently not provided by the loyalty rewards program, such that the participant can define any reward they desire even though the rewards program does not offer the reward.

In other specific embodiments of the invention, receiving one or more bids further includes receiving one or more bids to provide the desired loyalty program reward to the program participant, wherein each bid is equal to or less than the maximum rewards point amount that the program participant is willing to redeem for the desired loyalty program reward. In further related specific embodiments of the method, determining the winning bid further includes determining the winning bid based on a lowest bid received from amongst the one or more bids.

In other specific embodiments the method includes receiving one or more third inputs from the program participant, wherein each third input defines additional redemption criteria for the desired loyalty program reward, such as a desired product brand, travel time parameters or other attributes of the desired loyalty program reward. In such embodiments of the method, determining the winning bid further includes determining the winning bid based on the maximum rewards point amount that the program participant is willing to redeem for the desired loyalty program reward and the additional redemption criteria.

An apparatus for implementing a loyalty rewards program defines third embodiments of the invention. The apparatus includes a computing platform including a processor and a memory in communication with the processor. The apparatus further includes a loyalty rewards program module stored in the memory, executable by the processor and configured to determine, for each participant in a loyalty rewards program, a participant segment assignment from amongst a plurality of identified rewards program participant segments. The differentiated reward earn rates are provided to rewards program participants based on the determined participant segment assignment.

In specific embodiments of the apparatus, the loyalty rewards program module is further configured to determine, for each participant in a loyalty rewards program, a participant segment assignment from amongst a plurality of identified rewards program participant segments, wherein each segment is identified based on a rewards program-provider value of participants in the segment. Value may be defined as amount of business that the participants in the segment conduct with the rewards program-provider, the net worth of the participants in the segment or the like. In such embodiments of the apparatus, higher reward earn rates may be provided to rewards program participants based on the determined participant segment assignment being associated with lower valued participants and/or lower reward earn rates are provided to rewards program participants based on the determined participant segment assignment being associated with higher valued participants. In further related embodiments of the apparatus, fixed reward earn rates are provided to rewards program participants based on the determined participant segment assignment being associated with lower valued participants and/or dynamic reward earn rates are provided to rewards program participants based on the determined participant segment assignment being associated with higher valued participants. In such embodiments of the apparatus, dynamic rewards earn rates may be attributed to participant participation in reverse auctions, whereby the participant identifies a rewards and reward suppliers provide bids on the reward.

Another apparatus for implementing a loyalty rewards program provides for fourth embodiments of the invention. The apparatus includes a computing platform including a processor and a memory in communication with the processor. The apparatus further includes a loyalty rewards program participant interface module, stored in the memory, executable by the processor and configured to receive first and second inputs from a rewards program participant. The first input defines a desired loyalty program reward and the second input defines a maximum rewards point amount that the program participant is willing to redeem for the desired loyalty program reward. The apparatus further includes a loyalty rewards reverse auction module, stored in the memory, executable by the processor and configured to receive one or more bids for providing the desired loyalty program reward to the program participant, such that each bid is from one of a plurality of reward providers, and determine a winning bid from the one or more received bids based at least in part on the maximum rewards point amount that the program participant is willing to redeem for the desired loyalty program reward. Further, the program reward is provided to the program participant from the reward provider determined to be associated with the winning bid.

In specific embodiments of the apparatus, the loyalty rewards program participant interface module is further configured to receive the first input, wherein the first input defines a desired loyalty reward currently provided by the loyalty rewards program and/or a desired loyalty reward currently not provided by the loyalty rewards program. As such the participant may choose the reward from the program provider's catalog/inventory or the program provider may define their own reward.

In still further specific embodiments of the apparatus, the loyalty rewards reverse auction module is further configured to receive one or more bids to provide the desired loyalty program reward to the program participant, such that each bid is equal to or less than the maximum rewards point amount that the program participant is willing to redeem for the desired loyalty program reward. In related embodiments of the apparatus, the loyalty rewards reverse auction module is further configured to determine the winning bid based on a lowest bid received from amongst the one or more bids.

In still further embodiments of the apparatus, the loyalty rewards program participant interface module is further configured to receive one or more third inputs from the program participant, such that each third input defines additional redemption criteria for the desired loyalty program reward, such as product brand, travel parameters and the like. In such embodiments of the apparatus, the loyalty rewards reverse auction module is further configured to determine the winning bid based on the maximum rewards point amount that the program participant is willing to redeem for the desired loyalty program reward and the additional redemption criteria.

A computer program product provides for fifth embodiments of the invention. The computer program product includes a non-transitory computer-readable medium. The computer-readable medium includes a first set of codes for causing a computer to determine, for each participant in a loyalty rewards program, a participant segment assignment from amongst a plurality of identified rewards program participant segments. The differentiated reward earn rates are provided to rewards program participants based on the determined participant segment assignment.

Another computer program product defines sixth embodiments of the invention. The computer program product includes a non-transitory computer-readable medium. The computer-readable medium includes a first and second set of codes for causing a computer to receive a first and a second input from a rewards program participant. The first input defines a desired loyalty program reward and the second input defines a maximum rewards point amount that the program participant is willing to redeem for the desired loyalty program reward. The computer-readable medium additionally includes a third set of codes for causing a computer to receive one or more bids for providing the desired loyalty program reward to the program participant, wherein each bid is from one of a plurality of reward providers. Further, the computer-readable medium includes a fourth set of codes for causing a computer to determine a winning bid from the one or more received bids based at least in part on the maximum rewards point amount that the program participant is willing to redeem for the desired loyalty program reward. The program reward is provided to the program participant from the reward provider determined to be associated with the winning bid.

Thus, further details are described below for methods, apparatus and computer-program products that provide for a loyalty rewards program that provides differentiated earn rate rewards based on participant/customer segmentation. In specific embodiments the segmentation is based on value of the participant/customer as determined by the rewards program provider. Additionally further details are described below for methods, apparatus and computer-program products that provide for a rewards program that implements reverse auction type reward procurement. Such embodiments of the invention, offer differentiated rewards redemption based on the value of the participant to the program provider and the value that the participant/customer places on the reward.

To the accomplishment of the foregoing and related ends, the one or more embodiments comprise the features hereinafter fully described and particularly pointed out in the claims. The following description and the annexed drawings set forth in detail certain illustrative features of the one or more embodiments. These features are indicative, however, of but a few of the various ways in which the principles of various embodiments may be employed, and this description is intended to include all such embodiments and their equivalents.

### BRIEF DESCRIPTION OF THE DRAWINGS

Having thus described embodiments of the invention in general terms, reference may now be made to the accompanying drawings:

FIG. 1 is a block diagram of an apparatus configured for implementing a loyalty rewards program that provides differentiated earn rate rewards based on participant/customer segmentation, in accordance with embodiments of the present invention;

FIG. 2 is a block diagram of an apparatus configured for implementing a loyalty rewards program that includes reverse auction-type rewards provisioning, in accordance with embodiments of the present invention;

FIG. 3 is a flow diagram of a method for implementing a loyalty rewards program that provides differentiated earn rate rewards based on participant/customer segmentation, in accordance with embodiments of the present invention; and

FIG. 4 is flow diagram of a method for implementing a loyalty rewards program that includes reverse auction-type rewards provisioning, in accordance with embodiments of the present invention.

### DETAILED DESCRIPTION OF EMBODIMENTS OF THE INVENTION

Embodiments of the present invention now may be described more fully hereinafter with reference to the accompanying drawings, in which some, but not all, embodiments of the invention are shown. Indeed, the invention may be embodied in many different forms and should not be construed as limited to the embodiments set forth herein; rather, these embodiments are provided so that this disclosure may satisfy applicable legal requirements. Like numbers refer to like elements throughout.

As may be appreciated by one of skill in the art, the present invention may be embodied as a method, system, computer program product, or a combination of the foregoing. Accordingly, the present invention may take the form of an entirely software embodiment (including firmware, resident software, micro-code, etc.) or an embodiment combining software and hardware aspects that may generally be referred to herein as a “system.” Furthermore, embodiments of the present invention may take the form of a computer program product on a computer-readable medium having computer-usable program code embodied in the medium.

Any suitable computer-readable medium may be utilized. The computer-readable medium may be, for example but not limited to, an electronic, magnetic, optical, electromagnetic, or semiconductor system, apparatus, device, or propagation medium. More specific examples of the computer readable medium include, but are not limited to, the following: a tangible storage medium such as a portable computer diskette, a hard disk, a random access memory (RAM), a read-only memory (ROM), an erasable programmable read-only memory (EPROM or Flash memory), a compact disc read-only memory (CD-ROM), or other optical or magnetic storage device.

Computer program code for carrying out operations of embodiments of the present invention may be written in an object oriented, scripted or unscripted programming language such as Java, Perl, Smalltalk, C++, SAS or the like. However, the computer program code for carrying out operations of embodiments of the present invention may also be written in conventional procedural programming languages, such as the “C” programming language or similar programming languages.

Embodiments of the present invention are described below with reference to flowchart illustrations and/or block diagrams of methods, apparatus (systems), and computer program products. It may be understood that each block of the flowchart illustrations and/or block diagrams, and/or combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create mechanisms for implementing the functions/acts specified in the flowchart and/or block diagram block or blocks.

These computer program instructions may also be stored in a computer-readable memory that can direct a computer or other programmable data processing apparatus to function in a particular manner, such that the instructions stored in the computer readable memory produce an article of manufacture including instruction means which implement the function/act specified in the flowchart and/or block diagram block(s).

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the flowchart and/or block diagram block(s). Alternatively, computer program implemented steps or acts may be combined with operator or human implemented steps or acts in order to carry out an embodiment of the invention.

Thus, methods, apparatus and computer-program products are described in detail below that provide for a loyalty rewards program that provides differentiated earn rate rewards based on participant/customer segmentation. In specific embodiments the segmentation is based on value of the participant/customer as determined by the rewards program provider. Additionally further details are described below for methods, apparatus and computer-program products that provide for a rewards program that implements reverse auction type reward procurement. Such embodiments of the invention, offer differentiated rewards redemption based on the value of the participant to the program provider and the value that the participant/customer places on the reward.

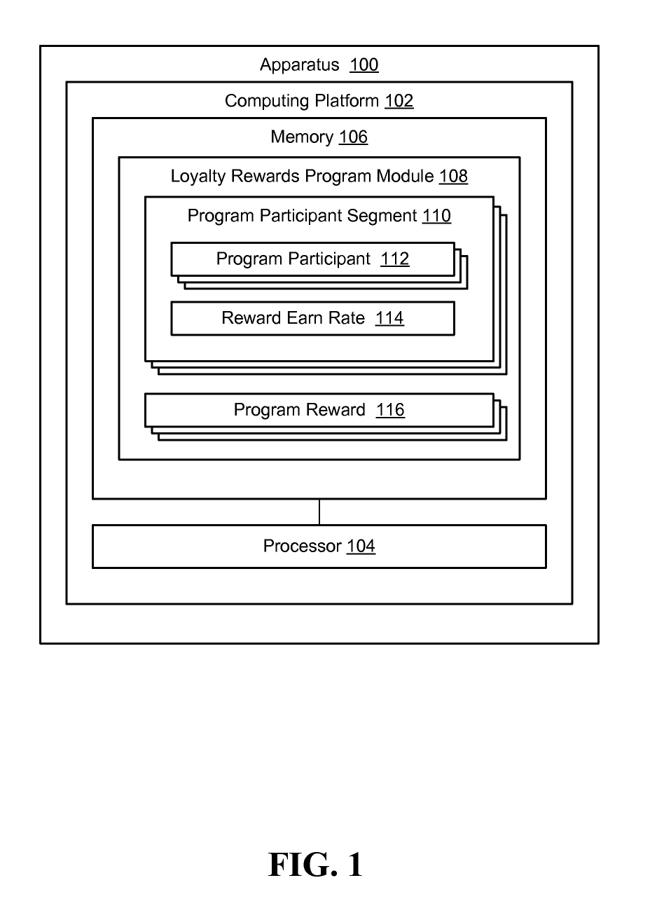

FIG. 1 is a block diagram of apparatus 100 configured for implementing a loyalty rewards program that provides differentiated earn rate rewards based on participant/customer segmentation, in accordance with embodiments of the present invention. The apparatus 100 includes a computing platform 102 having at least one processor 104 and a memory 106 in communication with the processor. The apparatus 100 may include any type of one or more computerized, communication devices, such as a server, a personal computer, a portable computer, or any device or devices that include a computer platform 102 and may have a wired and/or wireless connection to a network, such as the Internet, an intranet or the like.

The apparatus 100 includes computing platform 102 that may be configured to transmit data across a network, and that can receive and execute routines and applications. Computing platform 102 includes memory 106, which may comprise volatile and nonvolatile memory such as read-only and/or random-access memory (RAM and ROM), EPROM, EEPROM, flash cards, or any memory common to computing platforms. Further, memory 106 may include one or more flash memory cells, or may be any secondary or tertiary storage device, such as magnetic media, optical media, tape, or soft or hard disk.

Further, computing platform 102 also includes processor 104, which may be an application-specific integrated circuit (“ASIC”), or other chipset, processor, logic circuit, or other data processing device. Processor 104 or other processor such as ASIC may execute an application programming interface (“API”) layer (not shown in FIG. 1) that interfaces with any resident programs, such as loyalty program module 108 stored in the memory 106 of the apparatus 100.

Processor 106 includes various processing subsystems (not shown in FIG. 1) embodied in hardware, firmware, software, and combinations thereof, that may enable the functionality of apparatus 100 and the operability of the apparatus 100 on a network. For example, processing subsystems allow for initiating and maintaining communications, and exchanging data, with other networked devices. For the disclosed embodiments, processing subsystems of processor 100 may include any subsystem used in conjunction with loyalty rewards program module 108.

The memory 106 of apparatus 100 stores loyalty rewards program module 108. Loyalty rewards program module 108 is executable by processor 104 and configured to determine, a program participant segment 110 assignment for each program participant 112 from amongst a plurality of identified rewards program participant segments 110. Each program participant segment 110 has a different rewards earn rate 114 for rewards 116 in the rewards program, such that program participants 112 in the segment 110 earn rewards 116 based on reward earn rate 114 associated with their assigned program participant segment 110.

It should be noted that the term “rewards program participant” includes individual participants, as well as, a group of individuals that participate in unison, such that rewards points and the like may be accumulated by the individuals in the group and pooled together for subsequent redemption by the group of individuals. Thus, in those embodiments of the invention, discussed infra., in which the participant is afforded the capability to acquire a reward through a reverse auction, the group of individuals may identify a mutually agreed upon reward for subsequent reverse auction acquisition. Examples of a group of individuals includes, but is not limited to, a social network (e.g., a Facebook® group); a family/household; a fraternity/sorority; employees of a business, typically a small business; a charitable organization or the like.

In specific embodiments of the invention, the program participant segments 110 are identified or otherwise characterized by the value that the participants of the segment provide to the rewards program provider. In certain embodiments of the invention, value may be defined in terms of the amount of business, monetary or otherwise, that the participant conducts with the rewards program providers and, in some embodiments, the affiliates of the rewards program provider. In other embodiments, such as in those instances in which the rewards program provider is a financial institution or has access to participant's financial information, value may be defined in terms of the net worth of the participant or the like.

In one specific embodiment of the invention, program participant segments 110 may include a high value participant segment, medium value participant segment and a low value participant segment, such that the high value participant segment has the lowest rewards earn rate (e.g., the lowest amount of points required to redeem for specified rewards), the medium value participant segment has a medium rewards earn rate (e.g., a points amount required to redeem for specified rewards that is between the lowest and highest amount) and the low value participant segment has the highest rewards earn rate (e.g., the highest amount of points required to redeem for specified rewards).

In other specific embodiments of the invention, different reward earn rates may be defined in terms of fixed reward earn rates and dynamic reward earn rates. Fixed reward earn rates provide for each reward 116 to be assigned a finite number of reward points or the like required for reward redemption. For example, according to one specific embodiment of the invention, fixed reward earn rates may be provided to a participant segment 110 associated with lower valued participants or, in other embodiments, all participant segments 110 other than a high value participant segment. Dynamic reward earn rates provide for one or more rewards 116 to have point redemption amounts that may fluctuate or change. For example, according to one specific embodiment of the invention dynamic reward ear rates may be provided to a participant segment 110 associated with higher valued customers.

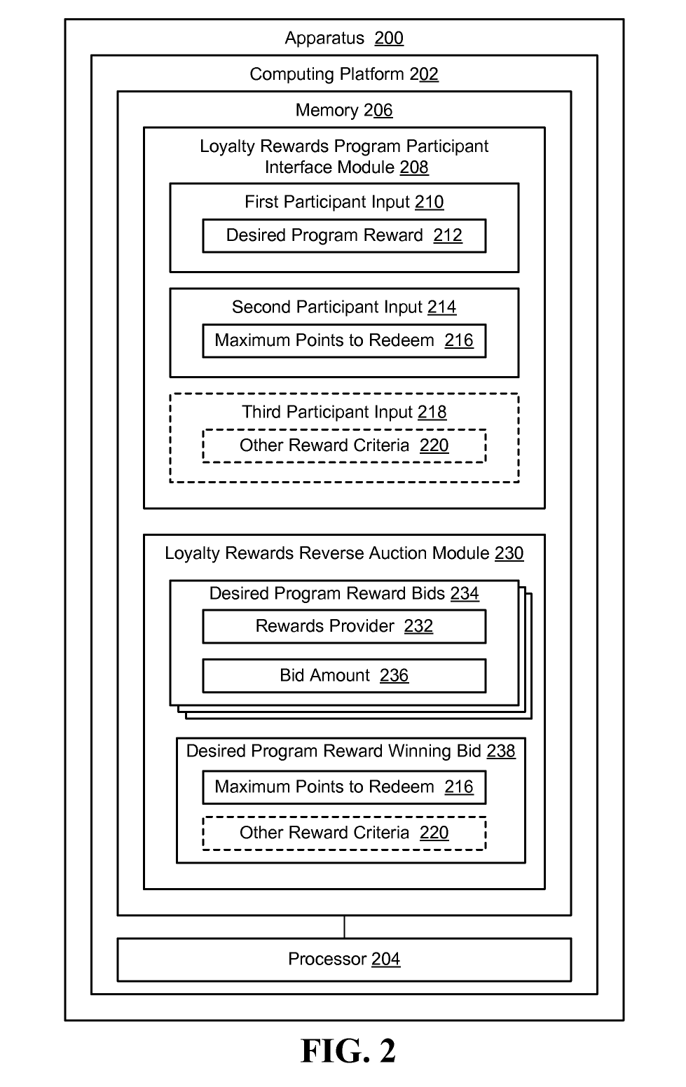

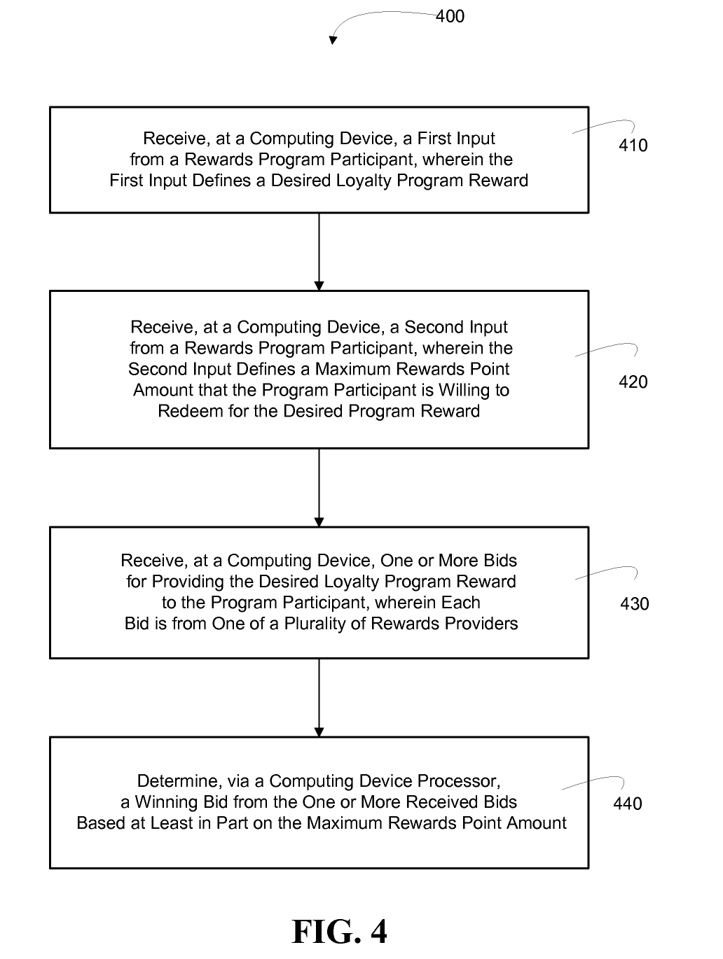

In specific embodiments of the invention, dynamic reward earn rates may be realized by implementation of a reverse auction model for procuring the program reward. In such embodiments, as described in more detail in relation to FIGS. 2 and 4, the participant may identify a reward and the maximum amount of points that they are willing to redeem for that reward. In turn, one or more rewards providers may bid on being the supplier of the reward and the supplier with the lowest bid, or the supplier that meets other reward provider criteria, is deemed to have the winning bid and provides the desired reward to the participant.

It should be noted that the different reward earn rates 114 that are associated with different participant segments 110 do not require that all rewards provided by the rewards program utilize the differing reward earn rate. In other words, some program rewards 116 may have the same earn rate regardless of which participant segment 110 the program participant 112 resides, while other program rewards 116 may be subject to different earn rates depending on which participant segment 110 the participant 112 resides.

FIG. 2 is a block diagram depiction of an apparatus 200 configured to implement a loyalty rewards program that includes reverse auction-type rewards provisioning, in accordance with an embodiment of the present invention. The apparatus 200 may include any type of one or more computerized, communication devices, such as a server, a personal computer, a portable computer, or any device or devices that include a computer platform 202 and may have a wired and/or wireless connection to a network, such as the Internet, an intranet or the like.

The apparatus 200 includes computing platform 202 that may be configured to transmit data across a network, and that can receive and execute routines and applications. Computing platform 202 includes memory 206, which may comprise volatile and nonvolatile memory such as read-only and/or random-access memory (RAM and ROM), EPROM, EEPROM, flash cards, or any memory common to computing platforms. Further, memory 206 may include one or more flash memory cells, or may be any secondary or tertiary storage device, such as magnetic media, optical media, tape, or soft or hard disk.

Further, computing platform 202 also includes processor 204, which may be an application-specific integrated circuit (“ASIC”), or other chipset, processor, logic circuit, or other data processing device. Processor 204 or other processor such as ASIC may execute an application programming interface (“API”) layer (not shown in FIG. 2) that interfaces with any resident programs, such as loyalty program participant interface module 208 and/or loyalty program reverse auction module 230 stored in the memory 106 of the apparatus 100.

Processor 106 includes various processing subsystems (not shown in FIG. 2) embodied in hardware, firmware, software, and combinations thereof, that may enable the functionality of apparatus 100 and the operability of the apparatus 100 on a network. For example, processing subsystems allow for initiating and maintaining communications, and exchanging data, with other networked devices. For the disclosed embodiments, processing subsystems of processor 100 may include any subsystem used in conjunction with loyalty program participant interface module 208 and/or loyalty program reverse auction module 230.

The memory 206 of apparatus 200 stores loyalty program participant interface module 208 that is configured to provide for program participants to identify desired program rewards which they wish to acquire and, according to embodiments herein disclosed, acquire via reverse auction procurement. As previously noted, reverse auction-type rewards provisioning adds value for the program provider, as well as, the rewards provider, in that, both the program provider and the rewards provider gain more knowledge about the participant and the like. The interface module 208 may be network accessible to the participant, such as via the Internet or the like, and provide the participant the ability to manage and track their performance in the rewards program.

Specifically, loyalty program participant interface module 208 is configured to receive and store first and second inputs 210, 214 from program participants, in which the first input 210 identifies a desired program reward 212 and the second input 214 defines the maximum point amount 216 that the program participant is willing to redeem for the rewards. As such the first input 210, which identifies and stores a desired program reward 212 acts similar to a conventional wish list or pre-order list. In one embodiment of the invention, the first input 210 may be received by capturing an image or video of the item/service with the participants smart-phone, camera or the like and posting (i.e., storing) the image/video within a participant rewards database, such as may be provided within the reward program's participant interface website or the like. It should be noted that the identified desired program reward 212 may be a reward currently existing in the program (e.g., a cataloged reward) or the desired program reward 212 may a reward that does not currently exist in the reward program. Such identification of desired program rewards 212 not currently in the program allows the participant to configure their own personal rewards and, as such, provides the program provider and/or reward provider more knowledge about the participant.

In addition to receiving first and second inputs, in some embodiments, loyalty program participant interface module 208 is configured to receive third input 218 that define other desired rewards criteria 220. Other reward criteria 220 may include, for example, the brand of a desired product/service, travel parameters, such as destination, time/date(s) and the like. Other rewards criteria 220 may serve as criteria for allowing reward providers to bid on the reward, such that only those reward providers that meet the criteria are allowed to bid or, in other embodiments, the other reward criteria 220 may be factored in to the determination of the winning bid.

Additionally, loyalty program participant interface module 208 may be configured to receive multiple first and second inputs from the participant, such that multiple rewards and associated maximum allowable points are defined by the participant. In such embodiments, loyalty program participant interface module 208 may be configured to receive prioritization inputs that prioritizes the participants desire to acquire the desired reward 212. Prioritization may provide for implementing reverse auctions in sequential fashion (i.e., highest prioritized reward first) to insure that the participant has sufficient reward points to redeem for a desired program reward 212 once an auction is completed. In other embodiments of the invention, in which the system is configured to allow the participant to participate in reverse auctions for different desired rewards 212 simultaneously, the successful completion of one auction may provide for other auction(s) to be cancelled in the event that the participant does not have sufficient rewards points to redeem for the desired reward in the event the other auction(s) were to close with winning bids or, in other embodiments, the participant may be allowed to purchase additional rewards points (e.g., incur a charge to a reward programs suppliers' credit card) to compensate for the points deficiency incurred by having the other auction(s) close with winning bids.

In the event that the participant has defined and prioritized more than one desired program reward 212 and the participant does not currently have enough rewards points to satisfy all of the rewards in the event that successful auctions would be completed for the more than one desired program rewards 212, the system may provide for recalling bids in the event that an auction closes a

Memory 206 of apparatus 200 additionally includes loyalty reward reverse auction module 230 configured to provide reward providers 232, otherwise referred to as rewards suppliers or vendors, the ability to bid on participant desired rewards. In specific embodiments of the invention the loyalty rewards reverse auction module is a network accessible, such as Internet accessible, application that allows authorized rewards providers, such as those rewards providers affiliated with the program provider, to attempt to fulfill participant desired rewards through a bidding process. Thus, loyalty reward reverse auction module 230 is configured to receive one or more bids 234 from one or more service providers 232. In specific embodiments, the starting or initial bid in the reverse auction may be set to the maximum amount of points 216 that the participant is willing to redeem for the reward.

It should be noted that in specific embodiments of the invention, two or more rewards providers 232 may collaborate together to provide a bid 234. For example, if the participant desired reward is a vacation/travel adventure that requires airline transportation and hotel/lodging accommodations, an airline rewards provider and a lodging rewards provider may collaborate to provide a bid. Alternatively, the system may provide for individual reverse auctions to be implemented for separate components of the rewards, for example, a first reverse auction for the airline/transportation portion of the desired reward 212 and a second reverse auction for the lodging portion of the desired reward 212.

In one embodiment of the invention, the reverse auction module 230 may be configured such that reward providers 232 may input bids 234 for a designated time period and the winning bid 238 is determined after the expiration of the time period. In certain embodiments of the invention, the reverse auction module 230 may be configured to provide the service providers 230 knowledge of the current lowest bid as the auction is ongoing or, in other embodiments of the invention, the reverse auction module 230 may be configured to conceal the received bids 234 from other service providers 232, commonly referred to as a blind or sealed bid auction.

In other embodiments of the invention, the reverse auction module 230 may be configured to implement a fixed type auction, in which the first bid 234 received from a reward supplier, which meets the maximum amount of reward points 216 that the participant is willing to redeem for the reward, is deemed the winning bid 238. The fixed type auction may be configured to be open-ended in duration based on the auction ending once a bid is received that meets the maximum amount of points that the participant is willing to redeem for the reward or the fixed type auction may be for a designated time period.

In additional embodiments of the invention, the reverse auction module 230 may be configured to determine the winning bid 238 based, not only on the maximum amount of reward points that the participant is willing to redeem, but also on other rewards criteria 220 as defined by the participant. As previously discussed, the desired rewards may be rewards currently offered by the program or the desired rewards may be rewards not currently offered by the program (i.e., participant configured rewards). In such instances, the participant may define and prioritize other rewards criteria 220 which may be used in the determination of the winning bid 238. This, in such embodiments of the invention, the lowest bid received during the reverse auction may not be winning bid 238 based on the other rewards criteria 220 providing for overriding factors in determining the winning bid. Such other rewards criteria may be a participant preferred brand, travel parameters, such as preferred service level, preferred dates and times and the like.

In further embodiments of the invention, a portion of the rewards providers 232 may be affiliated or otherwise partnered with the loyalty rewards program provider and, as such, provided preferential consideration in the auction process. For example, one or more affiliated or partnered reward providers 232 may be afforded the ability to provide the first or last bid in a reverse auction configured to last for a predetermined time period. In another example, one or more affiliated or partnered reward providers 232 may be afforded the ability to bid first on a fixed-type auction, in which the first bid which meets the maximum amount of reward points 216 that the participant is willing to redeem for the reward, is deemed the winning bid 238, prior to allowing non-affiliated or non-partnered reward providers 232 the ability to bid on providing the reward.

Such reverse auctions provide the program provider and reward supplier insight into what the interests and desires are of the participant. This type if information is especially useful if the participant is a high value participant/customer that is more prone to making transactions purchases and, in particular high end purchases. By having knowledge of the participants interests and desires, the program provider and/or reward supplier can tailor other offers, discounts and the like for participant that specifically meet the participant's interests or desires. In addition, reverse auctions provide additional value to the program participant, in that, the participant can have control over the redemption rate for the reward based on the participant defining up front the maximum amount of points they are willing to redeem for a reward.

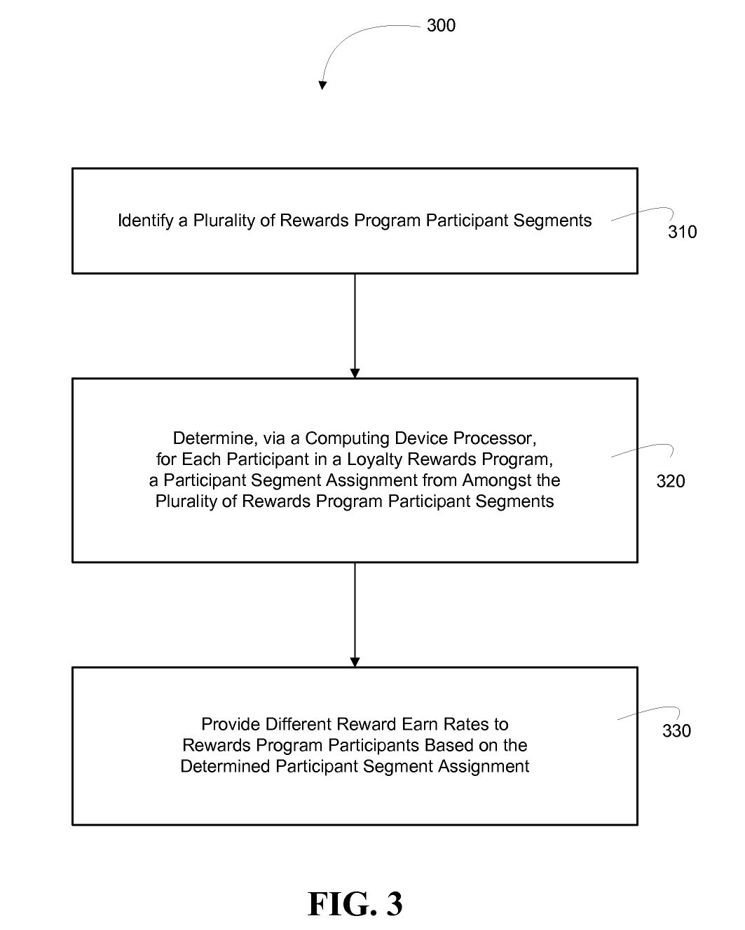

FIG. 3 is a flow diagram of a method 300 for implementing a loyalty rewards program that provides differentiated earn rate rewards based on participant/customer segmentation, in accordance with embodiments of the present invention. At Event 310, a plurality of rewards program participant segments are identified. In specific embodiments, the rewards program participant segments are based on the value that the participants provide to the program provider. For example, the plurality of rewards program participant segments may include a high value participant segment, a medium value participant segment, a low value participant segment and the like. In such embodiments of the invention, value may be defined as the amount of business that the participants in the segment conduct with the rewards program-provider, or, in those embodiments in which the program provider is a financial institution, the value may be the net worth of the participant or the like.

At Event 320, a participant segment assignment is determined for each participant in the loyalty rewards program. For example, in those embodiments in which the participant segment assignment is based on the program provider's value of the participant, participant segment assignment is determined by the program provider evaluating or otherwise assessing the value of their program participants.

At Event 330, differentiated reward earn rates are provided or otherwise assigned to rewards program participants based on their determined participant segment assignment. For example, in those embodiments in which the participant segments are based on the program provider's value of the participant, differentiated reward earn rates may provide for higher reward earn rates for a lower valued participant segment and/or lower reward earn rates for a higher valued participant segment. In other such embodiments of the method, differentiated reward earn rates may provide for fixed reward earn for lower valued participant segments or for all participants not assigned to a higher value participant segment and/or dynamic reward ear rates for high value participant segments. Dynamic reward earn rates may be realized through implementation of reverse or fixed type auctions in which participants identify desired program rewards and a maximum amount of points which they are willing to redeem for the desired reward and, subsequently, reward providers bid on the participant's desired reward resulting in, in some embodiments, the lowest bid providing the desired reward to the participant.

Referring to FIG. 4, a flow diagram is presented of a method 400 for implementing a loyalty rewards program that includes reverse auction-type rewards provisioning, in accordance with embodiments of the present invention. In specific embodiments of the invention, reverse auction provisioning of loyalty program rewards may be limited to specified segments of the overall program participant population, such as a high value segment of the program or the like. At Event 410 a first input, which defines a desired program reward, is received from a program participant. In specific embodiments of the method, the desired program reward may be a re-existing reward currently available in the rewards program. In other embodiments of the invention, the desired reward may not currently exist in the rewards program but instead be a reward configured by the participant, such as specific product or a specific travel itinerary/adventure.

At Event 420, a second input, that defines the maximum amount of points the participant is willing to redeem for the reward, is received from the program participant. In specific embodiments in which a convention reverse auction is implemented, the maximum amount of points the participant is willing to redeem for the reward serves as the starting point for receiving bids for reward providers and once an initial bid is received at the starting point, subsequent bids must be lower than the initial bid. In other embodiments in which a fixed type auction is implemented, the maximum amount of points the participant is willing to redeem for the reward serves as a pre-order for the desired reward, in which the first reward provider who bids on the reward at the stated maximum amount of points/price is deemed the winner and is obligated to provide the reward to the participant.

In other embodiments the method may include receiving third inputs, which define other rewards criteria, from the program participant. The other reward criteria may serve as limitations to reward providers participating in the auction, for example, if the product/service they provide does not meet the participant's other reward criteria. In other embodiments the other reward criteria may serve as factors for determining the winning bid. In such instances, the lowest bid received may not be the winning bid if other reward criteria presents overriding factors.

At Event 430, one or more bids are received from one or more reward providers, such that the bids are for providing the desired reward to the program participant. In specific embodiments, the one or more bids are equal to less than the maximum reward point amount that the program participant is willing to redeem for the desired loyalty program reward. In a fixed type auction, a single bid may be received that is equal to the maximum reward point amount that the program participant is willing to redeem for the desired loyalty program reward. While in a conventional non-sealed bid reverse auction, each bid received will be less than the previous bid, in order for the bid to be accepted. In a sealed/closed bid reverse auction, each bid received shall be equal to less than the maximum reward point amount that the program participant is willing to redeem for the desired loyalty program reward but no requirement is made that later received bids be less than previous bids due to the closed nature of the bidding process.

At Event 440, a winning bid is determined from amongst the received bids based, at least in part, on the maximum rewards point amount that the program participant is willing to redeem. In specific embodiment of the method, the winning bid is the lowest amount bid received, while in those embodiments in which a fixed auction is implemented, the first bud received is the winning bid. In further embodiments, in which other reward criteria is defined by the program participant, the winning bid may be based on the maximum rewards point amount that the program participant is willing to redeem and the other reward criteria. This, in such embodiments, the lowest bid received may not result in the winning bid, since the other reward criteria may factor in the determination of the winning bid.

Thus, embodiments of the invention described above provide for a loyalty rewards program that provides differentiated earn rate rewards based on participant/customer segmentation. In specific embodiments the segmentation is based on value of the participant/customer as determined by the rewards program provider. Additionally further details are described below for methods, apparatus and computer-program products that provide for a rewards program that implements reverse auction type reward procurement. Such embodiments of the invention, offer differentiated rewards redemption based on the value of the participant to the program provider and the value that the participant/customer places on the reward.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other updates, combinations, omissions, modifications and substitutions, in addition to those set forth in the above paragraphs, are possible.

Those skilled in the art may appreciate that various adaptations and modifications of the just described embodiments can be configured without departing from the scope and spirit of the invention. Therefore, it is to be understood that, within the scope of the appended claims, the invention may be practiced other than as specifically described herein.

1. A method for implementing a loyalty rewards program, the method comprising:
identifying a plurality of rewards program participant segments;
determining, via a computing device processor, for each participant in a loyalty rewards program, a participant segment assignment from amongst the plurality of rewards program participant segments; and
providing different reward earn rates to rewards program participants based on the determined participant segment assignment.

2. The method of claim 1, wherein identifying further comprises identifying the plurality of rewards program participant segments, wherein each segment is identified based on a rewards program-provider value of participants in the segment.

3. The method of claim 2, wherein providing different rewards earn rates further comprises providing higher reward earn rates to rewards program participants based on the determined participant segment assignment being associated with lower valued participants.

4. The method of claim 2, wherein providing different rewards earn rates further comprises providing lower reward earn rates to rewards program participants based on the determined participant segment assignment being associated with higher valued participants.

5. The method of claim 2, wherein identifying further comprises identifying the plurality of rewards program participant segments, wherein each segment is identified based on a rewards program-provider value of participants in the segment, wherein the rewards program-provider value of participants in the segment is further defined as a monetary amount of business that the participants in the segment conduct with the rewards program-provider.

6. The method of claim 2, wherein providing further comprises providing fixed reward earn rates to rewards program participants based on the determined participant segment assignment being associated with lower valued participants.

7. The method of claim 2, wherein providing further comprises providing dynamic reward earn rates to rewards program participants based on the determined participant segment assignment being associated with higher valued participants.

8. The method of claim 7, wherein providing further comprises providing dynamic reward earn rates to rewards program participants based on the determined participant segment assignment being associated with higher valued participants, wherein the dynamic earn rates are determined based on rewards provider participation in reverse auctions on rewards identified by participants.

9. A method for implementing a loyalty rewards program, the method comprising:
receiving, via a computing device, a first input from a rewards program participant, wherein the first input defines a desired loyalty program reward;
receiving, via a computing device, a second input from the rewards program participant, wherein the second input defines a maximum rewards point amount that the program participant is willing to redeem for the desired loyalty program reward;
receiving, via a computing device, one or more bids for providing the desired loyalty program reward to the program participant, wherein each bid is from one of a plurality of reward providers; and
determining, via a computing device processor, a winning bid from the one or more received bids based at least in part on the maximum rewards point amount that the program participant is willing to redeem for the desired loyalty program reward.

10. The method of claim 9, wherein receiving the first input, further comprises receiving the first input, wherein the first input defines a desired loyalty reward currently provided by the loyalty rewards program.

11. The method of claim 9, wherein receiving the first input, further comprises receiving the first input, wherein the first input defines a desired loyalty reward currently not provided by the loyalty rewards program.

12. The method of claim 9, wherein receiving one or more bids further comprises receiving, via a computing device, one or more bids to provide the desired loyalty program reward to the program participant, wherein each bid is equal to or less than the maximum rewards point amount that the program participant is willing to redeem for the desired loyalty program reward.

13. The method of claim 9, wherein receiving one or more bids further comprises receiving, via a computing device, one or more bids to provide the desired loyalty program reward to the program participant, wherein preferential bidding consideration is provided to reward providers that are affiliated with a loyalty rewards program provider.

14. The method of claim 9, wherein determining the winning bid further comprises determining the winning bid based on a lowest bid received from amongst the one or more bids.

15. The method of claim 9, further comprising receiving, via a computing device, one or more third inputs from the program participant, wherein each third input defines additional redemption criteria for the desired loyalty program reward.

16. The method of claim 9, wherein determining the winning bid further comprises determining, via the computing device the winning bid based on the maximum rewards point amount that the program participant is willing to redeem for the desired loyalty program reward and the additional redemption criteria.

17. The method of claim 9, wherein the rewards program participant is limited to participants in the program having a high value to a rewards program provider.

18. An apparatus for implementing a loyalty rewards program, the apparatus comprising:
a computing platform including a processor and a memory in communication with the processor; and
a loyalty rewards program module stored in the memory, executable by the processor and configured to determine, for each participant in a loyalty rewards program, a participant segment assignment from amongst a plurality of identified rewards program participant segments, wherein different reward earn rates are provided to rewards program participants based on the determined participant segment assignment.

19. The apparatus of claim 18, wherein the loyalty rewards program module is further configured to determine, for each participant in a loyalty rewards program, a participant segment assignment from amongst a plurality of identified rewards program participant segments, wherein each segment is identified based on a rewards program-provider value of participants in the segment.

20. The apparatus of claim 19, wherein the loyalty rewards program module is further configured to determine, for each participant in a loyalty rewards program, a participant segment assignment from amongst a plurality of identified rewards program participant segments, wherein higher reward earn rates are provided to rewards program participants based on the determined participant segment assignment being associated with lower valued participants.

21. The apparatus of claim 19, wherein the loyalty rewards program module is further configured to determine, for each participant in a loyalty rewards program, a participant segment assignment from amongst a plurality of identified rewards program participant segments, wherein lower reward earn rates are provided to rewards program participants based on the determined participant segment assignment being associated with higher valued participants.

22. The apparatus of claim 19, wherein the loyalty rewards program module is further configured to determine, for each participant in a loyalty rewards program, a participant segment assignment from amongst a plurality of identified rewards program participant segments, wherein each segment is identified based on a rewards program-provider value of participants in the segment, wherein the rewards program-provider value of participants in the segment is further defined as a monetary amount of business that the participants in the segment conduct with the rewards program-provider.

23. The apparatus of claim 19, wherein the loyalty rewards program module is further configured to determine, for each participant in a loyalty rewards program, a participant segment assignment from amongst a plurality of identified rewards program participant segments, wherein fixed reward earn rates are provided to rewards program participants based on the determined participant segment assignment being associated with lower valued participants.

24. The apparatus of claim 19, wherein the loyalty rewards program module is further configured to determine, for each participant in a loyalty rewards program, a participant segment assignment from amongst a plurality of identified rewards program participant segments, wherein dynamic reward earn rates are provided to rewards program participants based on the determined participant segment assignment being associated with higher valued participants.

25. The apparatus of claim 24, wherein the loyalty rewards program module is further configured to determine, for each participant in a loyalty rewards program, a participant segment assignment from amongst a plurality of identified rewards program participant segments, wherein dynamic reward earn rates are provided to rewards program participants based on the determined participant segment assignment being associated with higher valued participants, and wherein the dynamic earn rates are determined based on rewards provider participation in reverse auctions on rewards identified by participants.

26. An apparatus for implementing a loyalty rewards program, the apparatus comprising:
a computing platform including a processor and a memory in communication with the processor;
a loyalty rewards program participant interface module, stored in the memory, executable by the processor and configured to receive first and second inputs from a rewards program participant, wherein the first input defines a desired loyalty program reward and the second input defines a maximum rewards point amount that the program participant is willing to redeem for the desired loyalty program reward; and
a loyalty rewards reverse auction module, stored in the memory, executable by the processor and configured to receive one or more bids for providing the desired loyalty program reward to the program participant, wherein each bid is from one of a plurality of reward providers and determine a winning bid from the one or more received bids based at least in part on the maximum rewards point amount that the program participant is willing to redeem for the desired loyalty program reward,
wherein the program reward is provided to the program participant from the reward provider determined to be associated with the winning bid.

27. The apparatus of claim 26, wherein the loyalty rewards program participant interface module is further configured to receive the first input, wherein the first input defines a desired loyalty reward currently provided by the loyalty rewards program.

28. The apparatus of claim 26, wherein the loyalty rewards program participant interface module is further configured to receive the first input, wherein the first input defines a desired loyalty reward currently not provided by the loyalty rewards program.

29. The apparatus of claim 26, wherein the loyalty rewards reverse auction module is further configured to receive one or more bids to provide the desired loyalty program reward to the program participant, wherein each bid is equal to or less than the maximum rewards point amount that the program participant is willing to redeem for the desired loyalty program reward.

30. The apparatus of claim 26, wherein the loyalty rewards reverse auction module is further configured to receive one or more bids to provide the desired loyalty program reward to the program participant, wherein preferential bidding consideration is provided to reward providers that are affiliated with a loyalty rewards program provider.

31. The apparatus of claim 26, wherein the loyalty rewards reverse auction module is further configured to determine the winning bid based on a lowest bid received from amongst the one or more bids.

32. The apparatus of claim 26, wherein the loyalty rewards program participant interface module is further configured to receive one or more third inputs from the program participant, wherein each third input defines additional redemption criteria for the desired loyalty program reward.

33. The apparatus of claim 26, wherein the loyalty rewards reverse auction module is further configured to determine the winning bid based on the maximum rewards point amount that the program participant is willing to redeem for the desired loyalty program reward and the additional redemption criteria.

34. The apparatus of claim 26, wherein the rewards program participant is limited to participants in the program having a high value to a rewards program provider.

35. A computer program product, comprising:
a non-transitory computer-readable medium comprising:
a first set of codes for causing a computer to determine, for each participant in a loyalty rewards program, a participant segment assignment from amongst a plurality of identified rewards program participant segments, wherein different reward earn rates are provided to rewards program participants based on the determined participant segment assignment.

36. The computer program product of claim 35, wherein the first set of codes is further configured to cause the computer to determine, for each participant in a loyalty rewards program, a participant segment assignment from amongst a plurality of identified rewards program participant segments, wherein each segment is identified based on a rewards program-provider value of participants in the segment.

37. The computer program product of claim 36, wherein the first set of codes is further configured to cause the computer to determine for each participant in a loyalty rewards program, a participant segment assignment from amongst a plurality of identified rewards program participant segments, wherein higher reward earn rates are provided to rewards program participants based on the determined participant segment assignment being associated with lower valued participants.

38. The computer program product of claim 36, wherein the first set of codes is further configured to cause the computer to determine, for each participant in a loyalty rewards program, a participant segment assignment from amongst a plurality of identified rewards program participant segments, wherein lower reward earn rates are provided to rewards program participants based on the determined participant segment assignment being associated with higher valued participants.

39. The computer program product of claim 36, wherein the first set of codes is further configured to cause the computer to determine, for each participant in a loyalty rewards program, a participant segment assignment from amongst a plurality of identified rewards program participant segments, wherein each segment is identified based on a rewards program-provider value of participants in the segment, wherein the rewards program-provider value of participants in the segment is further defined as a monetary amount of business that the participants in the segment conduct with the rewards program-provider.

40. The computer program product of claim 36, wherein the first set of codes is further configured to cause the computer to determine, for each participant in a loyalty rewards program, a participant segment assignment from amongst a plurality of identified rewards program participant segments, wherein fixed reward earn rates are provided to rewards program participants based on the determined participant segment assignment being associated with lower valued participants.

41. The computer program product of claim 36, wherein the first set of codes is further configured to cause the computer to determine, for each participant in a loyalty rewards program, a participant segment assignment from amongst a plurality of identified rewards program participant segments, wherein dynamic reward earn rates are provided to rewards program participants based on the determined participant segment assignment being associated with higher valued participants.

42. The computer program product of claim 36, wherein the first set of codes is further configured to cause the computer to determine, for each participant in a loyalty rewards program, a participant segment assignment from amongst a plurality of identified rewards program participant segments, wherein dynamic reward earn rates are provided to rewards program participants based on the determined participant segment assignment being associated with higher valued participants, and wherein the dynamic earn rates are determined based on rewards provider participation in reverse auctions on rewards identified by participants.

43. A computer program product, comprising:
a non-transitory computer-readable medium comprising:
a first set of codes for causing a computer to receive a first input from a rewards program participant, wherein the first input defines a desired loyalty program reward;
a second set of codes for causing a computer to receive a second input from the rewards program participant, wherein the second input defines a maximum rewards point amount that the program participant is willing to redeem for the desired loyalty program reward;
a third set of codes for causing a computer to receive one or more bids for providing the desired loyalty program reward to the program participant, wherein each bid is from one of a plurality of reward providers; and
a fourth set of codes for causing a computer to determine a winning bid from the one or more received bids based at least in part on the maximum rewards point amount that the program participant is willing to redeem for the desired loyalty program reward.
wherein the program reward is provided to the program participant from the reward provider determined to be associated with the winning bid.

44. The computer program product of claim 43, wherein the first set of codes is further configured to cause the computer to receive the first input, wherein the first input defines a desired loyalty reward currently provided by the loyalty rewards program.

45. The computer program product of claim 43, wherein the first set of codes is further configured to cause the computer to receive the receive the first input, wherein the first input defines a desired loyalty reward currently not provided by the loyalty rewards program.

46. The computer program product of claim 43, wherein the third set of codes is further configured to receive one or more bids to provide the desired loyalty program reward to the program participant, wherein each bid is equal to or less than the maximum rewards point amount that the program participant is willing to redeem for the desired loyalty program reward.

47. The computer program product of claim 43, wherein the third set of codes is further configured to receive one or more bids to provide the desired loyalty program reward to the program participant, wherein preferential bidding consideration is provided to reward providers that are affiliated with a loyalty rewards program provider.

48. The computer program product of claim 43, wherein the fourth set of codes is further configured to cause the computer to determine the winning bid based on a lowest bid received from amongst the one or more bids.

49. The computer program product of claim 43, further comprising a fifth set of codes for causing a computer to receive one or more third inputs from the program participant, wherein each third input defines additional redemption criteria for the desired loyalty program reward.

50. The computer program product of claim 43, wherein the fourth set of codes is further configured to cause the computer to determine the winning bid based on the maximum rewards point amount that the program participant is willing to redeem for the desired loyalty program reward and the additional redemption criteria.

51. The computer program product of claim 43, wherein the rewards program participant is limited to participants in the program having a high value to a rewards program provider.
